(19) United States
(12) Patent Application Publication
(10) Pub. No.: US 2017/0333738 A1
(43) Pub. Date: Nov. 23, 2017

(54) FIRE EXTINGUISHING DEVICE

(71) Applicant: Espherical Life Barrier, S.A.U., Almoradi Alicante (ES)

(72) Inventor: Jose Antonio Hernandez Reina, Almoradi Alicante (ES)

(21) Appl. No.: 15/540,749

(22) PCT Filed: Dec. 30, 2014
(86) PCT No.: PCT/ES2014/070994

§ 371 Date: Jun. 29, 2017

(51) Int. Cl. A62C 3/02; A62C 13/64

(52) U.S. Cl. CPC A62C 3/025; A62C 13/64

(57) ABSTRACT

It is designed to be thrown a distance so that it can reach areas of difficult access and project the extinguishing agent achieving a fast extinguishing, it consists of a body (1) of spherical configuration in turn comprising a lower tank (4) which has a partially spherical configuration housing the extinguishing agent, which is formed by a first half-body (5) and a second half-body (5′) joined together, and an upper spray cap (7) equipped with spray nozzles (8) which are joined to the lower tank (4), and a solenoid valve (3) automatically or manually activated by remote control which allows the passage of the circulation of the extinguishing agent from the tank (4) to the spray nozzles (8) for its mass propagation from said spray nozzles (8) towards the exterior to extinguish the flames.

### OBJECT OF THE INVENTION

The present invention relates to a device for fire extinguishing that is devised to be thrown at a distance so that it can reach areas of difficult access and project the extinguishing agent achieving a fast extinguishing.

The invention describes a special constitution and configuration of the device to house the extinguishing agent and the projection agent optimally, also integrating the necessary elements to guarantee the activation and the operation of the device in the place of action in controlled form.

### BACKGROUND OF THE INVENTION

There are various problems when extinguishing fires in buildings, height being an added problem in the case of absence of extinguishing means integrated in the building and/or the impossibility of accessing by the firemen due to the height limitations of the ladders used by the firemen and/or due to the lack of water pressure to reach high storeys.

As a solution to this problem the development of some devices have been provided to put out fires which may be thrown from an aeroplane or helicopter or using a launcher designed with this purpose.

In that sense, devices have been provided such as that disclosed in patent EP2033764, belonging to the same applicant of the present invention, comprising a body designed to be thrown inside a building, which is activated by detonation and which consists of at least one actuator which activates a detonator, which causes the explosion of a charge, which determines the expansion of a fire resistant component contained in the body, which is spread over a wide radius of action, putting out the flames.

The actuator may be activated due to impact or remotely by remote control or the action of a timer.

Other know solutions have provided that the device comprises a body which incorporates an aqueous solution as extinguishing agent, wherein denotation means are integrated which activate an explosive charge, which once exploded cause the projection of small drops of atomized liquid which absorb the heat and considerably decrease the temperature of the flames.

In these cases, the device activation occurs due to the detonation of an explosive charge which causes the projection of an extinguishing agent. This concept of incorporating an explosive charge and its detonator involves a risk factor due to the possibility that an uncontrolled detonation occurs.

### DESCRIPTION OF THE INVENTION

The fire-extinguishing device proposed by the present invention resolves the aforementioned problem satisfactorily using a body, of spherical configuration which is devised to be remotely thrown and which is fundamentally equipped with a pressurized tank housing the extinguishing agent, and which houses the instrumentation and the actuation means which allow the controlled and programmed spraying or mass propagation of the extinguishing agent through spray nozzles.

The extinguishing device is devised with a particular geometry which makes it possible to house the extinguishing agent in pressurized and hermetic form, and facilitate its uniform and multidirectional projection at the required instant after which the device reaches the place of the fire, by the actuation of a commanded opening and closing element, normally a solenoid valve. The activation of the solenoid valve is performed automatically or in programmed form, once previously established set-points have been detected and exceeded, or manually by remote control, for example, radiofrequency.

In this case, unlike other solutions, it does not incorporate a detonator, or any explosive charge and the projection of the extinguishing agent is performed in controlled form by actuation on the solenoid valve.

The body of spherical configuration is formed by a lower tank of partially spherical configuration, preferably formed by two lower half bodies with the intermediation of an o-ring, and by an upper spray cap which is joined to the upper face of the tank completing the spherical form of the body, with the cap integrating the spray nozzles radially distributed in the proximity of its pole.

The instrumentation is located on the upper face of the tank and housed inside of the spray cap in the mounting situation of the body, being provided that the solenoid valve is disposed between the spray nozzles and the tank, so that the activation of the solenoid valve determines the outlet of the extinguishing agent from the pressurized tank towards the spray nozzles and from them projected at pressure towards the exterior.

It has been provided that the tank housing the extinguishing agent incorporates on the inner walls of each one of the half-bodies stiffening ribs which provide resistance to impact, in this way minimizing the deformation that may be caused as a consequence of the impact suffered by the body after being thrown against the floor of the premises wherein the fire to be extinguished occurs.

On the front surface of one of the half-bodies of the tank a housing is defined designed to house the o-ring, preferably toric, which would partially protrude and be pressed by the front surface of the other half-body which configures the tank in the coupling situation of both half-bodies. To guarantee the joint between both half-bodies it has been provided that each one of them has axially opposite bores designed to receive fixing means, preferably bolts which pass through both halves and the corresponding nuts.

Likewise, to establish the joint between the spray cap and the upper face of the tank it has been provided that the cap integrates axial bores designed for the passage of fixing means, which would preferably consist of threaded blind nuts and bolts defined in the upper face of the tank, designed to receive said bolts.

The device incorporates the instrumentation or control electronics, which manages the monitoring of the main parameters, such as temperature, tank pressure, relative angular position and deceleration, and allows its remote actuation.

The device consists of several programmable modes of operation, in automatic and manual programming.

In automatic mode it has provided the possibility that the solenoid valve is activated and the spraying occurs of the extinguishing agent according to the following parameters:
Time, the device makes it possible to programme a timing, and is activated in the place of the fire after that predetermined time has elapsed,
Temperature, the device is activated in the place of the fire at a pre-established temperature,
Pressure, the device controls the tank pressure and is activated once a preset reference pressure is reached,
Deceleration, the device is programmed in impact mode and detects a sudden deceleration due to impact, which determines the device activation.

In manual mode the device would be remotely activated at any time at the choice of the operator by remote control from the place of control wherein the operator is found.

It has also been provided that the body incorporates counterweights which facilitate the vertical positioning thereof after its throwing and once it impacts or rolls on the surface of the place to extinguish the fire, so that the spray nozzles are aimed in the upper position to achieve a maximum projection and, therefore, a greater range of the extinguishing agent. These counterweights are preferably located in the base of the tank.

It is contemplated that the extinguishing agent is preferably ABC powder, which is stored in the tank together with the propulsion agent, which may be nitrogen, for example, without discarding the possibility of using other solid, gaseous or liquid extinguishing agents.

On the other hand, it has been provided that the body incorporates an intumescent paint which makes it possible to protect it against high temperatures.

Complementarily, the device may incorporate an inertial positioning system which makes it possible to control the final location reached by the device in the premises where it has been thrown, consisting of an emitter which would emit a signal that determines the relative location of the device with respect to a base point.

The device of the present invention is devised for its use in fires, in the necessary number to put out the fire or at least help in the extinguishing tasks that are going to be executed by the firemen, throwing several units in different areas of the same building or premises. The possibility of having a positioning system in each device facilitates control over the location and distribution of the devices thrown into the premises, and therefore of the need to throw more devices and define the optimum position wherein they should fall in the premises to achieve maximum coverage in the fire extinguishing.

Each one of the devices may also be generically or individually programmed, all of the devices following the same pattern or being programmed differently in line with different parameters and or set-points.

In another possible complementary embodiment it has also been provided that the device incorporates a display system consisting of vision cameras integrated in the body, which may be of 360° vision type and high thermal protection, in combination with an emitter, which sends by radiofrequency the images captured to a control post where the data displayed are viewed and recorded, providing real-time images of the situation of the inside of the premises in flames. The possibility of having images of the interior during the fire also facilitates the actuation and strategy to be followed by the fire brigade.

### DESCRIPTION OF THE DRAWINGS

To complement the description being made and in order to aid towards a better understanding of the characteristics of the invention, in accordance with a preferred example of practical embodiment thereof, a set of drawings is attached as an integral part of said description wherein, with illustrative and non-limiting character, the following has been represented:

FIG. 1.—Shows a perspective view of the device object of the invention wherein the spray cap is observed separated with respect to the tank leaving the instrumentation visible.

FIG. 2.—Shows a perspective view of the tank.

FIG. 3.—Shows a perspective view of one of the half-bodies of the tank.

FIG. 4.—Shows a front view of the half-body of the preceding figure.

FIG. 5.—Shows a sectional view of the device in the mounting situation wherein the position of the solenoid valve between the tank and the spray cap is observed.

FIG. 6.—Shows a perspective view of the spray cap.

### PREFERRED EMBODIMENT OF THE INVENTION

In light of the figures, a preferred embodiment is described below of the fire-extinguishing device which forms the object of this invention.

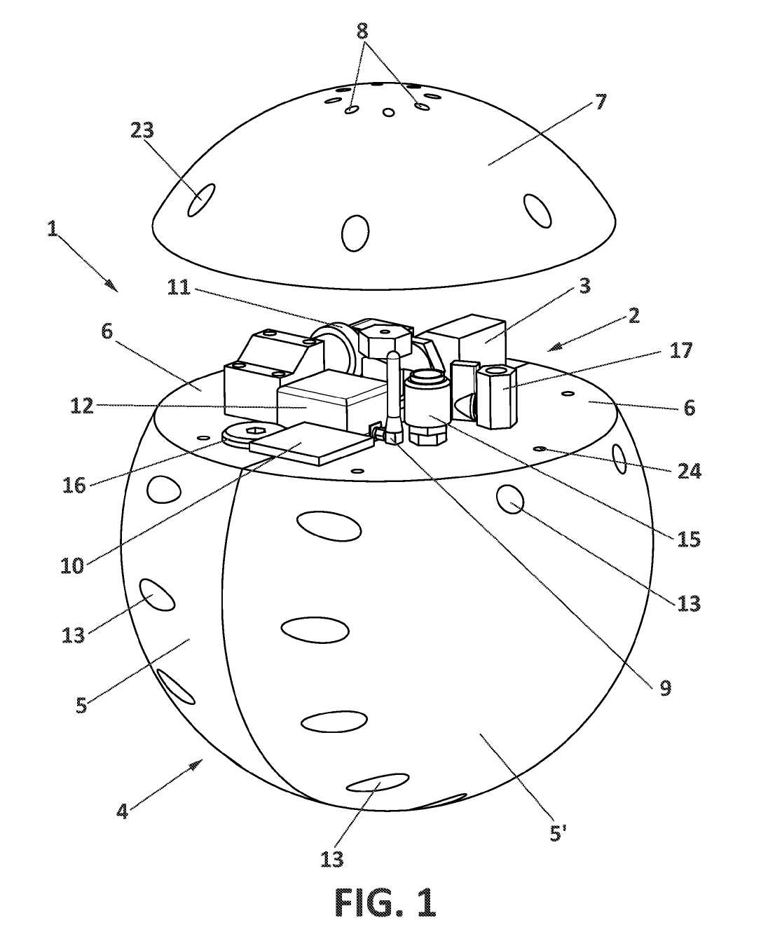

As observed in FIG. 1, the fire-extinguishing device comprises a body (1) of spherical configuration comprising: a lower tank (4) of partially spherical configuration housing the extinguishing agent, which is formed by a first half-body (5) and a second half-body (5′) joined together, and an upper spray cap (7) equipped with spray nozzles (8) which are joined to the lower tank (4) completing the spherical form of the body (1).

The tank (4) has an upper face (6) whereon is found instrumentation (2) and a solenoid valve (3), also represented in FIG. 5, which determines, by automatic or manual remote actuation, the opening of the solenoid valve (3) and the consequent circulation of the extinguishing agent from the tank (4) to the spray nozzles (8) and its mass propagation from said spray nozzles (8) towards the exterior with the purpose of extinguishing the flames of a fire.

In FIG. 1 it can also be observed that the instrumentation (2) comprises an antenna (9) devised for the reception of orders, normally from a distant remote control unit commanded by the operator, a pressure transducer (11) which controls the pressure inside of the tank (4) and an electronic plate (10) connected to the antenna (9) and to the pressure transducer (11), as well as to the solenoid valve (3), wherein the electronic plate (10) records the different parameters to control such as pressure, temperature, deceleration and angular position, and acts on the solenoid valve (3) for its automatic opening once the parameters exceed predefined set-points or after receiving the order from the remote control unit.

The electronic plate (10) may integrate an accelerometer and a temperature sensor, also providing for the possibility that the electronic plate (10) is connected to another temperature sensor which may be located on the inner wall of the body (1).

Complementarily it has been provided that the device incorporates a battery (12), also represented in FIG. 1, which would feed the equipment that form part of the instrumentation (2).

In FIG. 1 it is also possible to see the different inlets and outlets of the tank (4), specifically a quick connector (15) is represented for the filling of the tank (4) with the propulsion agent, as well as observing a filling buffer (16) which allows the passage of extinguishing agent to the interior of the tank (4) and a drain valve (17) which would normally integrate a safety valve to give outlet to the tank (4) content in critical situations.

FIG. 5 shows a discharge opening (18) of the tank (4), and the mounting of the solenoid valve (3) with respect to it and the spray nozzles (8). The discharge opening (18) is internally connected to a siphon tube (19) interior to the tank (4) wherethrough the extinguishing agent will rise once the solenoid valve (3) is activated, to the spray nozzles (8) wherefrom the extinguishing agent would propagate to the outside.

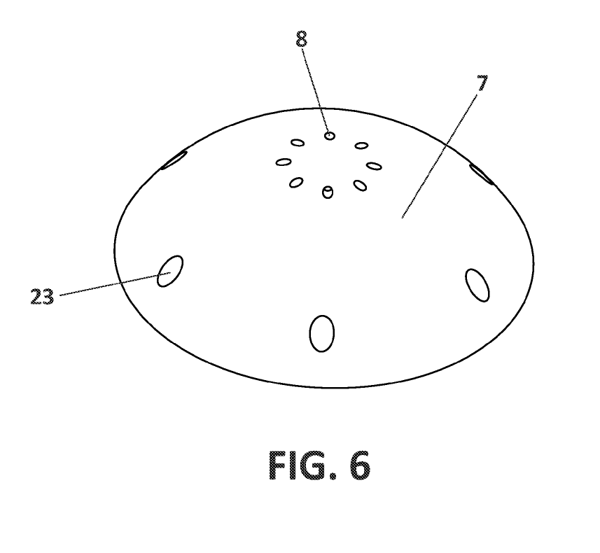

The spray nozzles (8), as observed in this FIG. 5 or in FIG. 6, are radially distributed around the pole of the spray cap (7), and are connected to the solenoid valve (3) with intermediation of an upper cap (20) represented in FIG. 5.

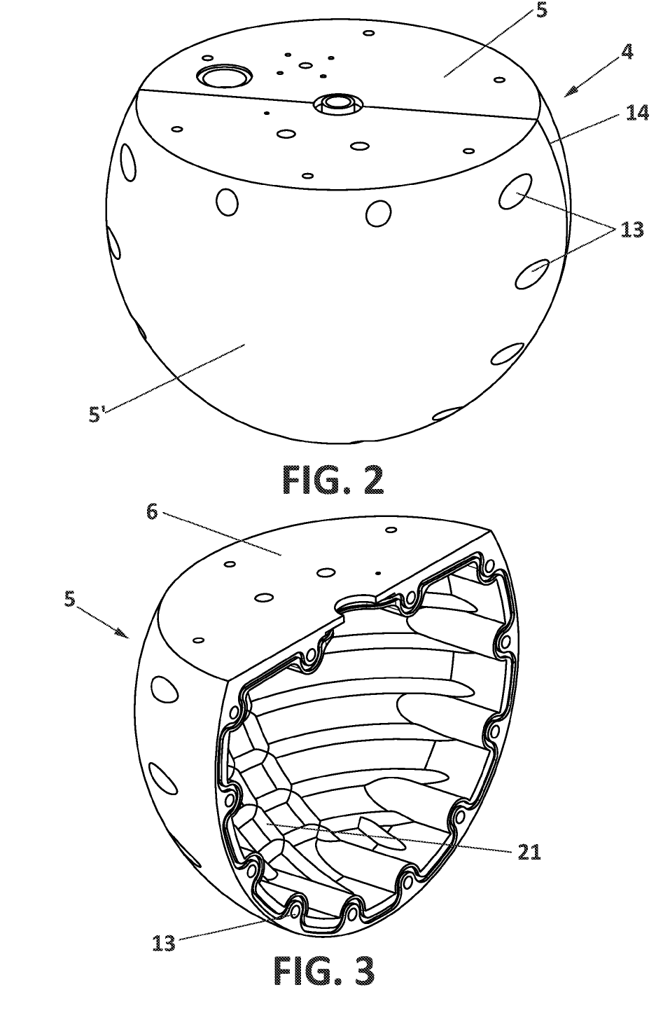

Furthermore, in FIG. 2 it is observed how the tank (4) is formed with the half-bodies (5, 5′) joined with the intermediation of an o-ring (14), wherein the half-bodies (5, 5′) are joined together preferably by fixing means such as corresponding bolts which pass through first bores (13) defined in the walls of the half-bodies (5, 5′) and corresponding nuts.

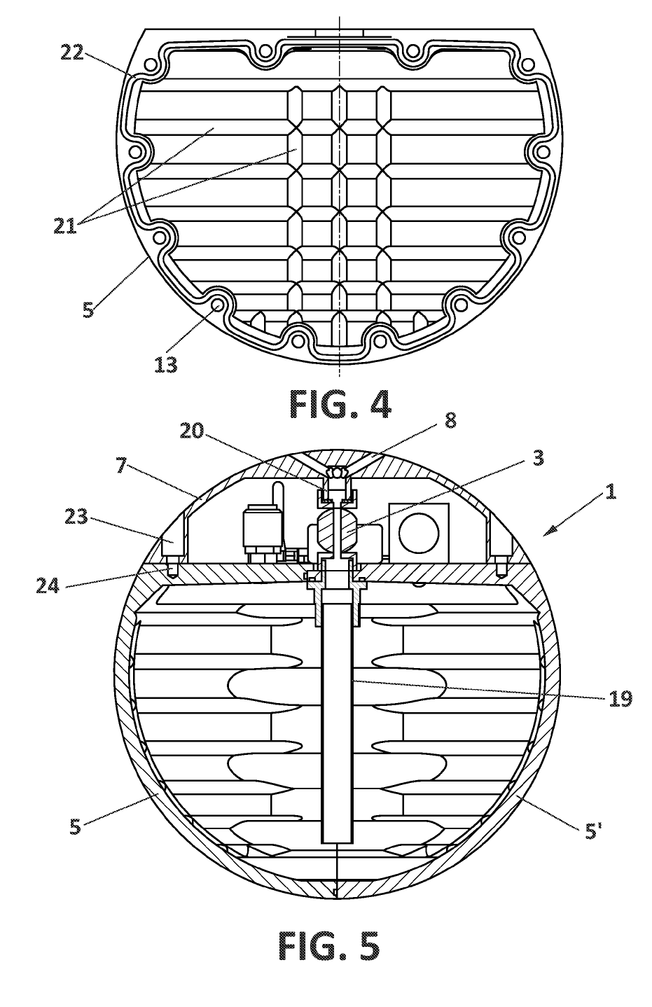

FIG. 3 internally shows one of the half-bodies (5, 5′), specifically the first half-body (5), where it shows with greater detail the location of the first bores (13), as well as it is possible to see stiffening ribs (21) which are defined in the inner walls of the half-body (5). The stiffening ribs (21) are also observed in greater detail in FIG. 4.

In this FIG. 4 it can also be observed that on the front or perimeter wall of the first half-body (5) is located a housing (22) preferably continuous and sinusoidal which is designed to partially receive the O-ring (14) represented in FIG. 2, which on the other side would simply rest on the front or perimeter wall frontal of the second half-body (5′) in the mounting situation of both forming the tank (4).

On the other hand, in FIG. 6 it is observed that the spray cap (7) is equipped with second bores (23) designed for the passage of bolts which would thread in threaded blind bores (24), represented in FIG. 1, and defined in the upper face (6) of the tank (4), to in this way establish the mounting of the spray cap (7) on the tank (4).

1. Fire-extinguishing device comprising a body (1) of spherical configuration housing an extinguishing agent and a propulsion agent, and which houses instrumentation (2) and actuation means which allow the mass propagation commanded by automatic or manual remote actuation of the extinguishing agent, characterized in that it comprises:
a body (1) of spherical configuration in turn comprising:
a lower tank (4), equipped with an upper face (6), which has a partially spherical configuration housing the extinguishing agent, which is formed by a first half-body (5) and a second half-body (5′) joined together, and
an upper spray cap (7) equipped with spray nozzles (8) which are joined to the lower tank (4) completing the spherical form of the body (1),
a solenoid valve (3) which closes or allows passage of the circulation of the extinguishing agent from the tank (4) to the spray nozzles (8) for its mass propagation from said spray nozzles (8) towards the exterior with the purpose of extinguishing the flames of a fire, and
instrumentation (2) situated on the upper face (6) which determines the activation of the solenoid valve (3) automatically or manually by remote control.

2. Fire-extinguishing device according to claim 1, wherein the tank (4) additionally comprises an o-ring (14) situated between the half-bodies (5, 5′), and said half-bodies (5, 5′) have first bores defined in their walls designed to receive fixing means which interconnect the half-bodies (5, 5′) with intermediation of the O-ring (14).

3. Fire-extinguishing device according to claim 1, wherein the inner walls of the half-body (5) incorporate stiffening ribs (21).

4. Fire-extinguishing device according to claim 1, wherein the instrumentation (2) comprises:
an antenna (9) devised for the reception of orders from a distant remote control unit commanded by the operator,
a pressure transducer (11) which controls the pressure inside of the tank (4),
an electronic plate (10) connected to the antenna (9) and to the pressure transducer (11), as well as to the solenoid valve (3),
wherein the electronic plate (10) records the different parameters to control such as pressure, temperature, deceleration and angular position, as well as sending a signal to the solenoid valve (3) for its automatic opening once the parameters exceed predefined set-points or after receiving the order from the remote control unit.

5. Fire-extinguishing device according to claim 1, wherein the electronic plate (10) integrates an accelerometer.

6. Fire-extinguishing device according to claim 1 wherein the electronic plate (10) integrates a temperature sensor.

7. Fire-extinguishing device according to claim 1, additionally comprising a temperature sensor located on the inner wall of the body (1) which is connected to the electronic plate (10).

8. Fire-extinguishing device according to claim 1 or 4, additionally comprising a battery (12) which feeds the instrumentation (2).

9. Fire-extinguishing device according to claim 1 or 4, wherein the tank (4) comprises a discharge opening (18) for the propelled outlet of the extinguishing agent, a quick connector (15) for the filling thereof with the propulsion agent, a filling buffer (16) which allows the passage of extinguishing agent to the interior of the tank (4) and a drain valve (17) for the emptying of the tank (4) in critical circumstances.

10. Fire-extinguishing device according to claim 9, wherein the discharge opening (18) is internally connected to a siphon tube (19) interior to the tank (4) wherethrough the extinguishing agent will rise and it is connected to the solenoid valve (3).

11. Fire-extinguishing device according to claim 1, wherein the spray nozzles (8) are radially distributed in the upper cap (7) around its pole.

12. Fire-extinguishing device according to claim 1, comprising an upper cap (20) which connects the solenoid valve (3) with the spray nozzles (8).

13. Fire-extinguishing device according to claim 2, wherein the first half-body (5) comprises a housing (22) designed to partially receive the O-ring (14).

14. Fire-extinguishing device according to claim 1 wherein the instrumentation (2) additionally comprises an inertial positioning system which integrates an emitter which emits a signal which determines the relative location of the device with respect to a base point.

15. Fire-extinguishing device according to claim 1, wherein the body (1) integrates in its outer surface a display system consisting of vision cameras.

16. Fire-extinguishing device according to claim 1, wherein the tank (4) incorporates a counterweight in its base.
